(19) United States
(12) Patent Application Publication
(10) Pub. No.: US 2024/0228102 A1
(43) Pub. Date: Jul. 11, 2024

(54) MULTI-COMPARTMENT STORAGE DEVICE AND MOBILE DEVICE STAND AND METHOD FOR USING THE SAME

(71) Applicant: KystBox Inc., Germantown, MD (US)

(72) Inventor: Cheryl Lohman, Germantown, MD (US)

(21) Appl. No.: 18/240,341

(22) Filed: Aug. 30, 2023

Related U.S. Application Data
(60) Provisional application No. 63/373,873, filed on Aug. 30, 2022.

(51) Int. Cl. B65D 1/36; B65D 25/20; B65D 43/16; B65D 43/22; H04M 1/04

(52) U.S. Cl. CPC B65D 1/36; B65D 25/20; B65D 43/16; B65D 43/22; H04M 1/04; B65D 2543/00194

(57) ABSTRACT

A personal item storage apparatus configured for use in a medical setting to securely store a patient's personal items such as glasses, mobile device, dentures, medications, keys, and other similar items. The storage apparatus is equipped with multiple containers, each of varying sizes. Each container has a lid which pivots about at least one hinge. A latch and/or lock is present for each container to secure the lid to a housing of the apparatus. A mobile device stand is present at a top end of the storage apparatus which facilitates storage and placement of the mobile device of the patient in an upright orientation such that its handsfree use is unimpeded. A charging mechanism is preferably present to provide power to the mobile device even during use.

### FIELD OF THE PRESENT INVENTION

The present invention relates to the field of storage mechanisms, and more specifically relates to a multi-compartment storage device and mobile device stand which is specially configured for use in a medical bedside setting.

### BACKGROUND OF THE PRESENT INVENTION

Conventionally, individuals staying in a hospital, nursing home, or similar medical setting are assigned a room in which they are provided a bed. The room is rarely equipped with a standard ‘nightstand’ but usually has a folding tray table which may be extended over the bed of the patient to facilitate eating and drinking easily. The tray table may also be used to store the personal effects of the patient. However, this usually leaves the patients items in a disorganized fashion, and items can become lost accidentally. Additionally, using the tray table for personal items makes it difficult to use the tray for eating when it is mealtime, and therefore the tray must be cleared off prior to use. Clearing the tray can take time, as there may be multiple items that must be moved, and everything cannot be moved simultaneously and instantly by a nurse or visitor.

If there were a way in which patients could store their personal belongings easily and safely, while still maintaining the primary utility of the bedside tray, patient's stay in a medical facility room would be more pleasant. Additionally, if patients had an easy location to place a mobile device such as a table computer or smartphone, they could easily browse the internet and watch videos from their hospital bed without needing to hold the device the whole time.

Thus, there is a need for a device configured to facilitate the storage of a patient's personal items securely, as well as to prop upright and store a mobile device such as a tablet computer or smartphone for use. Such a device is preferably equipped with multiple storage compartments, each having a lid which snaps or locks into a closed position to securely store personal items of the patient. Such a device is preferably sized to perfectly fit on top of conventional trays commonly employed in a medical bedside setting, similar in dimensions to that of a cafeteria tray.

### SUMMARY OF THE PRESENT INVENTION

The present invention is a personal storage device and mobile device stand configured for use within a medical setting to facilitate the comfort of the patient, and to ensure their personal items remain secure and easily accessible without obstructing use of the beside tray and eating table. Multiple compartments of the device are each equipped with a lid which preferably latches closed to ensure the security of the items stored therein.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 exhibits a flow chart detailing the process of use of the present invention by a patient.

FIG. 2 depicts a view of the apparatus of the present invention as seen from the top and side.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a storage apparatus for personal items. The apparatus is specifically configured for use within a medical setting, preferably within a patient room, and is designed to be disposed at the bedside of the patient, on a conventional rolling table-top meal tray table.

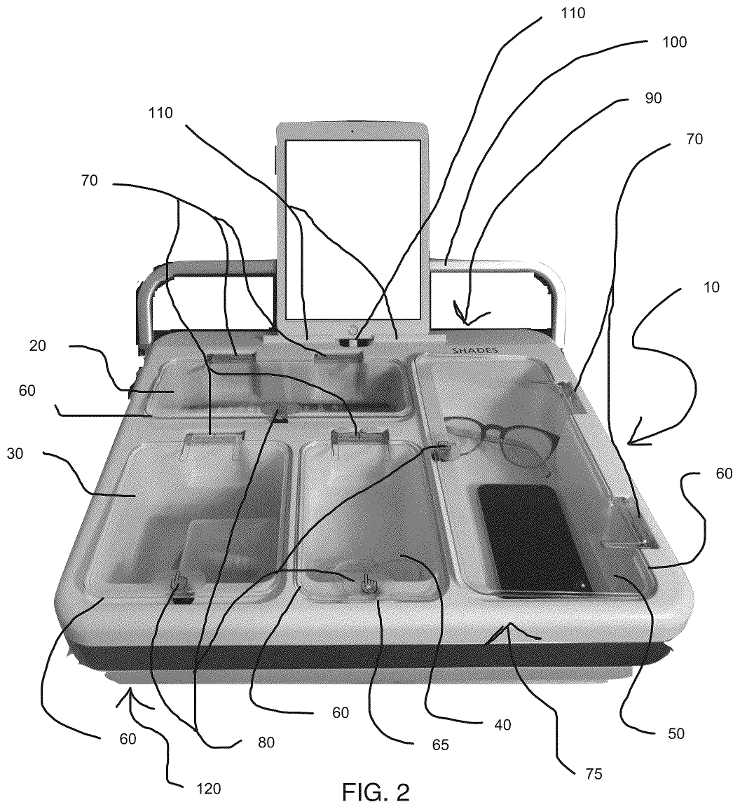

The preferred embodiment of the present invention is equipped with a housing (10) having at least four compartments: a large horizontal compartment (20) configured and sized to hold a conventional television remote control, a first rectangular compartment (30), a second rectangular compartment (40), and a third rectangular compartment (50); the third rectangular compartment (50) sized to hold a conventional mobile device such as a smartphone as well as sunglasses or eyeglasses at the same time as the conventional mobile device. Each of the compartments is equipped with a lid (60) which is preferably transparent or translucent. At least one of the compartments is equipped with a recess (65) which provides for a cable to pass through, facilitating continual charging of the mobile device while it remains within the compartment. Each lid (60) is configured to pivot about hinges (70), which facilitate the opening and closing of compartments (20, 30, 40. 50). Hinges (70) are configured with a conventional sound dampening mechanism that is compatible with user's having sound sensitivity such as post-traumatic stress disorders—so while the user can hear clicks and other sounds associated with opening and closing each lid (60), the clicks and other sounds are not loud enough to act as triggers for those with post-traumatic stress disorders. Further, each compartment (20, 30, 40. 50) is equipped with a latch (80) disposed at an end of each compartment (20, 30, 40. 50), opposite that of the hinges (70) as depicted in FIG. 2.

Preferably, hinges (70) are positioned so that each compartment (20, 30, 40. 50) has a lid (60) that opens away or to the left or right of a bottom (75) of housing (10), since the user would typically access the housing (10) from an angle near the bottom (75) of the housing (10)—so any lid (60) is positioned to open so as to not impede user access to each compartment (20, 30, 40. 50).

At a top (90) of the housing (10), a mobile device stand (100) may optionally be provided. The mobile device stand (100) is preferably equipped with a charging apparatus (111) such as a Universal Serial Bus (USB) connection, including, but not limited to a Lightning Connector™, a USB-C male cable, a USB-micro male cable, a USB-mini male cable, or other similarly conventional charging cable connector. Additionally, rear (120) of the mobile device stand (100) may be equipped with a wireless charging standard, such as Qi™ or MagSafe™ to facilitate the charging of the patient's mobile device wirelessly from the mobile device stand (100). It should be noted that in the example embodiment shown, the mobile device stand (100) also functions as a handle for grabbing and moving the housing (10). The mobile device stand (100) is configured to securely hold a conventional mobile device (such as a smart phone or tablet) because a lip (111) is disposed on the top (90) of the housing (10). The mobile device stand (100) is configured to support a back of the mobile device while the lip (111) is configured to prevent a bottom the mobile device from moving or sliding, as shown in FIG. 2. Note the noticeable gap in housing (10) separating lip (111) to allow for active charging of the mobile device.

Dimensions of the housing (10) preferably mirror that of a conventional table-top tray, cafeteria tray, or similarly sized tray table commonly found in medical settings, used when the patient wishes to eat. The present invention enables quick conversion of such a table from an easily accessible entertainment platform to a mealtime platform, as a nurse or other individual present may easily move the entire housing (10), thereby moving all of the patient's personal items instantly, clearing the way for meal time. Further, if desired, the patient may place the meal atop the housing (10) of the present invention, with each lid (60) of each compartment closed, allowing them to continue to charge and use their mobile device during the meal. The top of the housing (10) is relatively flat, allowing easy meal placement atop the housing (10). Curved edges are preferably present on all parts of the present invention to prevent injury from sharp edges.

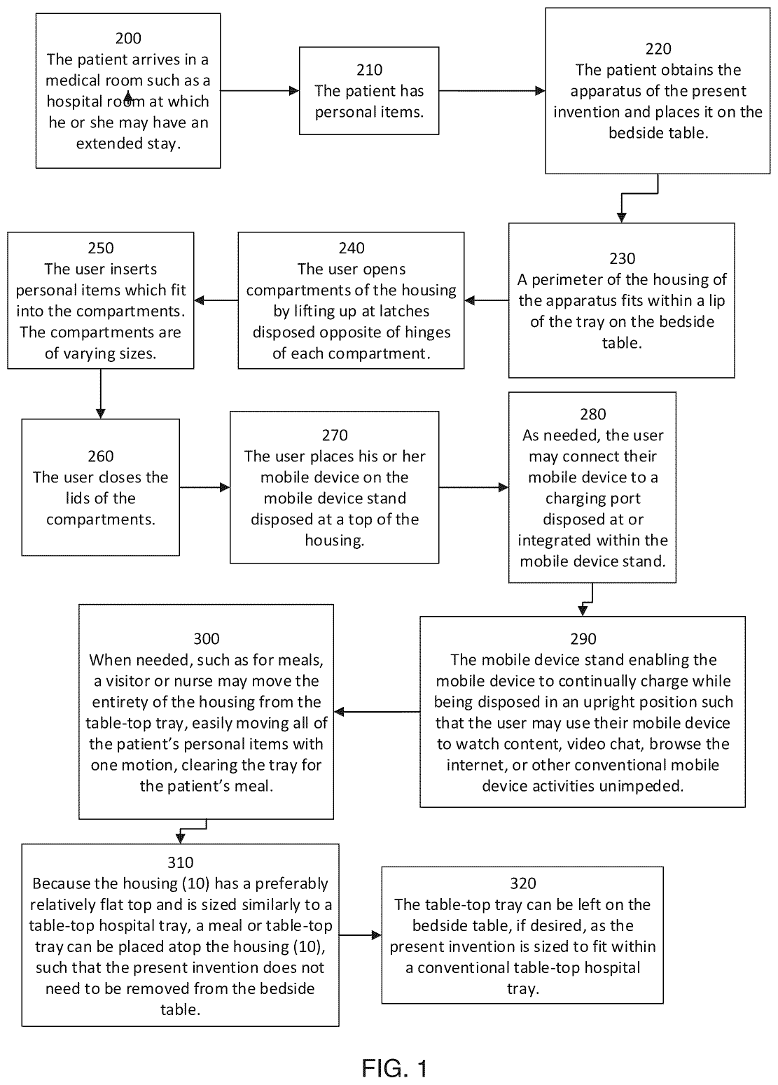

An example process of use for the example hardware embodiment shown in FIG. 1 is as follows:
1. The patient arrives in a medical room such as a hospital room at which he or she may have an extended stay. (200)
2. The patient has personal items. (210) The personal items may include dentures, hearing aids, glasses or sunglasses, a mobile device, a wallet, a watch, keys, or similar items.
3. The patient obtains the apparatus of the present invention and places it on the bedside table. (220) The bedside table is conventionally configured to extend above and over the bed of the patient such that he or she may eat and use the table right in front of them.
4. A perimeter of the housing of the apparatus fits within a lip of the tray on the bedside table. (230)
5. The user opens compartments of the housing by lifting up at latches disposed opposite of hinges of each compartment. (240)
6. The user inserts personal items which fit into the compartments. The compartments are of varying sizes. (250)
7. The user closes the lids of the compartments. (260)
8. The user places his or her mobile device on the mobile device stand disposed at a top of the housing. (270)
9. As needed, the user may connect their mobile device to a charging port disposed at or integrated within the mobile device stand. (280)
10. The mobile device stand enabling the mobile device to continually charge while being disposed in an upright position such that the user may use their mobile device to watch content, video chat, browse the internet, or other conventional mobile device activities unimpeded. (290)
11. When needed, such as for meals, a visitor or nurse may move the entirety of the housing from the table-top tray, easily moving all of the patient's personal items with one motion, clearing the tray for the patient's meal. (300)
12. Because the housing (10) has a preferably relatively flat top and is sized similarly to a table-top hospital tray, a meal or table-top tray can be placed atop the housing (10), such that the present invention does not need to be removed from the bedside table. (310)
13. The table-top tray can be left on the bedside table, if desired, as the present invention is sized to fit within a conventional table-top hospital tray. (320)

In some alternate embodiments of the present invention, each compartment may be equipped with a locking feature which enables additional security. In such embodiments, a button is preferably present adjacent to each latch (80) which may unlock the lid (60) of the corresponding compartment. Further, in some of such embodiments, a keypad may be present to enable a pin-locked mechanism. In such embodiments, the patient must enter a unique, patient-defined pin into the keypad to enable the button to unlock a latch (80) of a lid (60) of a compartment. It should be noted that conventional biometric technology could be employed to open any lid (60). Further, conventional global positioning systems could be in place such that the present invention could be tracked and located if lost and/or stolen.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A process for storing personal items while admitted to a medical facility, comprising the steps of:
a. providing an apparatus having a bottom surface, a top surface, and a plurality of storage compartments disposed between said top and bottom surfaces, said storage compartments opening toward said top surface and having a plurality of hinged lids, each disposed to cover one of said storage compartments, and movable between an open position allowing placement of an item in said one compartment and a closed position where said item is retained in said one compartment by a latch;
b. placing the apparatus on a supporting surface in the medical facility;
c. opening said lid corresponding to said compartment;
d. placing a personal item in said compartment, said personal item comprising one of dentures, hearing aids, eyewear, and a mobile electronic device;
e. closing and latching said lid corresponding to said compartment;
f. subsequently, reopening said compartment by operating said latch and retrieving said personal item.

2. The process of claim 1 wherein said bottom surface is sized to fit within a lip formed on an upper surface of a standard bedside table, whereby a potential sliding movement of said apparatus off said upper surface of said bedside table is opposed by contact of the apparatus with said lip.

3. The process of claim 1 wherein at least two of said compartments are different in size and are dimensioned to accommodate at least two of dentures, hearing aids, eyewear, a mobile electronic device, a wristwatch, and keys.

4. The process of claim 3 wherein four compartments are provided, including a compartment dimensioned to hold each of dentures, hearing aids, eyewear, and a mobile phone.

5. The process of claim 1 wherein the apparatus further comprises a smart phone support element disposed on the upper surface of the apparatus.

6. The process of claim 5 comprising the further step of placing a smart phone in contact with said support element in a position where the user is able to engage in at least one of: watching content, video chatting, browsing the internet, and other conventional mobile device activities.

7. The process of claim 2 comprising the further step of moving the apparatus from said bedside table and placing a meal tray on said bedside table in place of said apparatus.

8. The process of claim 1 wherein said top surface of said apparatus is substantially flat and sized similarly to a table-top hospital tray, whereby a meal tray can be placed atop and supported by the apparatus during use of said meal tray.
